(19) United States
(12) Patent Application Publication
(10) Pub. No.: US 2026/0074252 A1
(43) Pub. Date: Mar. 12, 2026

(54) SYSTEMS AND METHODS FOR CAPTURING CARBON DIOXIDE USING A MOLTEN CARBONATE FUEL CELL

(71) Applicant: FuelCell Energy, Inc., Danbury, CT (US)

(72) Inventors: Kamo Avanessian, Copley, OH (US); Hossein Ghezel-Ayagh, New Milford, CT (US)

(21) Appl. No.: 19/320,313

(22) Filed: Sep. 5, 2025

Related U.S. Application Data
(60) Provisional application No. 63/693,488, filed on Sep. 11, 2024.

(51) Int. Cl. H01M 8/0668; H01M 8/04111; H01M 8/04119; H01M 8/14

(52) U.S. Cl. CPC H01M 8/0668; H01M 8/04111; H01M 8/04171; H01M 8/145; H01M 2008/147

(57) ABSTRACT

A fuel cell system includes a molten carbonate fuel cell module including an anode section configured to output an anode exhaust stream including carbon dioxide and hydrogen and a cathode section configured to receive a cathode input stream. The fuel cell system further includes a drying system configured to receive and remove water from the anode exhaust stream and to output a dried anode exhaust stream comprising less than 0.1 percent water and a carbon dioxide solvent extraction system configured to receive the dried anode exhaust stream, expose the dried anode exhaust stream to a physical solvent to absorb carbon dioxide, output a carbon dioxide product stream comprising at least 99 percent carbon dioxide, and output a sweet gas stream.

### CROSS-REFERENCE TO RELATED APPLICATION

This application claims the benefit of and priority to U.S. Provisional Patent Application No. 63/693,488, filed on Sep. 11, 2024, which is incorporated by reference herein in its entirety.

### BACKGROUND

Molten carbonate fuel cells utilize hydrogen and/or other fuels to generate electricity. The basic structure of a molten carbonate fuel cell includes a cathode, an anode, and an electrolyte matrix positioned between the cathode and anode. The electrolyte matrix includes one or more molten carbonate salts that serve as an electrolyte. During operation, fuel (such as hydrogen gas or natural gas) may be supplied to the anode, and a gas stream including oxygen and carbon dioxide may be supplied to the cathode. When natural gas is used as a fuel, the methane in the natural gas may be reformed in the presence of a catalyst at the anode to form hydrogen.

The molten carbonate salts in the electrolyte matrix partially diffuse into the pores of the cathode, forming an interface region where the O₂ and CO₂ react to form carbonate ions (CO₃²⁻) that are transported across the electrolyte to the anode. At the anode, the carbonate ions react with the hydrogen to form water and carbon dioxide. Electrons released at the anode travel through an external circuit to the cathode, generating an electrical current.

Molten carbonate fuel cells are useful for capturing carbon dioxide, as carbon dioxide in the cathode input stream is essentially transported across the electrolyte to the anode and separated from the other gases in the cathode input stream. In one potential configuration, flue gas from power plants and other industrial processes can be used as part of the cathode input stream. The anode exhaust released from the anode typically includes carbon dioxide and water formed in the anode-side reactions, as well as unreacted fuel. It may be desirable for the unreacted fuel, water, and carbon dioxide to be separated from each other so that the carbon dioxide can be stored, and the unreacted fuel can be recycled or captured for other purposes. For example, a molten carbonate fuel cell using natural gas as a fuel source may be used both to capture carbon dioxide from a flue gas and to produce purified hydrogen from the natural gas stream.

### SUMMARY

At least one aspect of the present disclosure relates to a fuel cell system including a molten carbonate fuel cell module including an anode section and a cathode section, wherein the anode section is configured to output an anode exhaust stream including carbon dioxide and hydrogen, and the cathode section is configured to receive a cathode input stream, a drying system configured to receive and remove water from the anode exhaust stream and to output a dried anode exhaust stream including less than 0.1 percent water, and a carbon dioxide solvent extraction system configured to receive the dried anode exhaust stream, expose the dried anode exhaust stream to a physical solvent to absorb carbon dioxide, output a carbon dioxide product stream including at least 99 percent carbon dioxide, and output a sweet gas stream. In some embodiments, the physical solvent is propylene carbonate. In some embodiments, the anode section is configured to receive an anode input stream including at least a portion of the sweet gas stream.

In some embodiments, the fuel cell system further includes a catalytic converter configured to receive an air stream and at least a portion of the sweet gas stream, oxidize the at least the portion of the sweet gas stream, and output a catalytic converter output stream. In some embodiments, the cathode input stream includes the catalytic converter output stream.

In some embodiments, the fuel cell system further includes a pressure-swing adsorption system configured to receive at least a portion of the sweet gas stream and to output a product hydrogen stream including at least 99 percent hydrogen and a flash recycle stream. In some embodiments, the anode section is configured to receive an anode input stream including at least a portion of the flash recycle stream. In some embodiments, the fuel cell system further includes a catalytic converter configured to: receive an air stream and at least a portion of the sweet gas stream, oxidize the at least the portion of the sweet gas stream, and output a catalytic converter output stream. In some embodiments, the cathode input stream includes the catalytic converter output stream.

In some embodiments, the carbon dioxide solvent extraction system includes an absorption tower configured to receive a solvent input stream including the physical solvent, receive an absorber input stream including the dried anode exhaust stream, expose the absorber input stream to the physical solvent, output the sweet gas stream, and output an absorber output stream including physical solvent and carbon dioxide.

In some embodiments, the carbon dioxide solvent extraction system includes a first separation vessel configured to separate the absorber output stream into a first separator output stream including hydrogen and a first solvent output stream including carbon dioxide absorbed in physical solvent, a second separation vessel configured to separate the first solvent output stream into a second separator output stream including at least 99 percent carbon dioxide and a second solvent output stream including carbon dioxide absorbed in physical solvent, and a third separation vessel configured to separate the second solvent output stream into a third separator output stream including at least 99 percent carbon dioxide and a third solvent output stream including physical solvent.

In some embodiments, the absorber input stream includes the first separator output stream. In some embodiments, the fuel cell system further includes a compressor configured to pressurize the first separator output stream, and a heat exchanger configured to transfer heat from the pressurized first separator output stream to the sweet gas stream. In some embodiments, the second separation vessel is configured to output the second separator output stream at a pressure above 30 pounds per square inch, and the third separation vessel is configured to output the third separator output stream at approximately atmospheric pressure. In some embodiments, the carbon dioxide solvent extraction system further includes a compressor configured to pressurize the third separator output stream, wherein the carbon dioxide product stream includes the second separator output stream and the pressurized third separator output stream. In some embodiments, the solvent input stream includes physical solvent from the third solvent output stream.

In some embodiments, the fuel cell system further includes a carbon dioxide compression and storage system configured to receive the carbon dioxide product stream.

At least one other aspect of the present disclosure relates to a method of operating a molten carbonate fuel cell system, the method including removing water from an anode exhaust stream from an anode section of a molten carbonate fuel cell module to generate a dried anode exhaust stream including less than 0.1 percent water, exposing the dried anode exhaust stream to a physical solvent to absorb carbon dioxide in the dried anode exhaust stream and generate a sweet gas stream including hydrogen, and separating carbon dioxide from the physical solvent to generate a carbon dioxide product stream including at least 99 percent carbon dioxide. In some embodiments, the physical solvent is propylene carbonate. In some embodiments, the method further includes supplying to the anode section an anode input stream including at least a portion of the sweet gas stream.

In some embodiments, the method further includes oxidizing at least a portion of the sweet gas stream in a catalytic converter to generate a catalytic converter output stream, and supplying to a cathode section of the molten carbonate fuel cell system a cathode input stream including the catalytic converter output stream.

In some embodiments, the method further includes separating at least a portion of the sweet gas stream into a product hydrogen stream including at least 99 percent hydrogen and a flash recycle stream using pressure-swing adsorption. In some embodiments, the method further includes supplying at least a portion of the flash recycle stream to the anode section. In some embodiments, the method further includes oxidizing at least a portion of the flash recycle stream in a catalytic converter to generate a catalytic converter output stream, and supplying to a cathode section of the molten carbonate fuel cell system a cathode input stream including the catalytic converter output stream.

In some embodiments, exposing the dried anode exhaust stream to a physical solvent includes supplying a physical solvent input stream including the physical solvent to an absorption tower, supplying an absorber input stream including the dried anode exhaust stream to the absorption tower, and exposing the absorber input stream to the physical solvent in the absorption tower to generate an absorber output stream including carbon dioxide absorbed in physical solvent.

In some embodiments, separating carbon dioxide from the physical solvent includes reducing the pressure of the absorber output stream in a first separation vessel to separate the absorber output stream into a first separator output stream including hydrogen and a first solvent output stream including carbon dioxide absorbed in physical solvent, reducing the pressure of the first solvent output stream in a second separation vessel configured to separate the first solvent output stream into a second separator output stream including at least 99 percent carbon dioxide and a second solvent output stream including carbon dioxide absorbed in physical solvent, and reducing the pressure of the second solvent output stream in a third separation vessel configured to separate the second solvent output stream into a third separator output stream including at least 99 percent carbon dioxide and a third solvent output stream including physical solvent.

In some embodiments, the absorber input stream includes the first separator output stream. In some embodiments, the method further includes pressurizing the first separator output stream, and transferring heat from the pressurized first separator output stream to the sweet gas stream. In some embodiments, the method further includes pressurizing the third separator output stream and combining the pressurized third separator output stream with the second separator output stream. In some embodiments, the method further includes compressing and storing the combined second and third separator output streams. In some embodiments, the physical solvent input stream includes physical solvent from the third solvent output stream.

### BRIEF DESCRIPTION OF THE DRAWINGS

FIG. 1 is a schematic diagram of a molten carbonate fuel cell system according to an exemplary embodiment.

FIG. 2 is a schematic diagram of a molten carbonate fuel cell system according to an exemplary embodiment.

FIG. 3 is a schematic diagram of a carbon dioxide solvent extraction system of the molten carbonate fuel cell system of FIG. 2 according to an exemplary embodiment.

FIG. 4 is a schematic diagram of a compression and dewatering system of the molten carbonate fuel cell system of FIG. 2 according to an exemplary embodiment.

FIG. 5 is a schematic diagram of a hydrogen capture system of the molten carbonate fuel cell system of FIG. 2 according to an exemplary embodiment.

FIG. 6 is a schematic diagram of a portion of the molten carbonate fuel cell system of FIG. 2 according to an exemplary embodiment.

It will be recognized that the figures are schematic representations for purposes of illustration. The figures are provided for the purpose of illustrating one or more implementations with the explicit understanding that the figures will not be used to limit the scope of the meaning of the claims.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

As discussed above, it may be desirable to produce energy using a molten carbonate fuel cell while capturing both purified carbon dioxide and purified hydrogen. The fuel cell systems disclosed herein provide energy-efficient systems and methods for capturing carbon dioxide from the anode exhaust of a molten carbonate fuel cell module. In some embodiments, the systems and methods may also allow for the production of purified hydrogen. Gas separated from the purified hydrogen and carbon dioxide may be recycled for use as fuel in the molten carbonate fuel cell module, oxidized and used as oxidant in the molten carbonate fuel cell module, or used for other purposes within or outside of the molten carbonate fuel cell system. The systems and methods may produce more than 99 percent (or more than 99.9 percent) pure carbon dioxide using less energy and equipment than typical systems.

According to an exemplary embodiment, a system may utilize a carbon dioxide extraction system that utilizes a physical solvent such as propylene carbonate to capture carbon dioxide from an anode exhaust stream of a molten carbonate fuel cell system. The carbon dioxide may be absorbed from the anode exhaust by the physical solvent in a physical solvent absorber, and then the carbon dioxide may be separated from the physical solvent. A three-stage separation process may be used to separate the carbon dioxide from the physical solvent by gradually reducing the pressure on the physical solvent and carbon dioxide mixture. The gas separated in the first stage, which may include hydrogen and nitrogen in addition to carbon dioxide, may be recycled back to the physical solvent absorber, while the gas separated in the second and third stages, which may be nearly pure carbon dioxide, may be captured, providing a substantially pure carbon dioxide stream. The anode exhaust may undergo a water-gas shift reaction and water may be removed from the water-gas shifted anode exhaust before the anode exhaust is provided to a physical solvent absorber. This may improve the efficiency of the separation process both by removing water and by reducing the temperature and increasing the pressure of the dried anode exhaust stream. A residual sweet gas stream produced by the physical solvent absorber may be provided to a pressure-swing adsorption system to produce a substantially pure hydrogen stream.

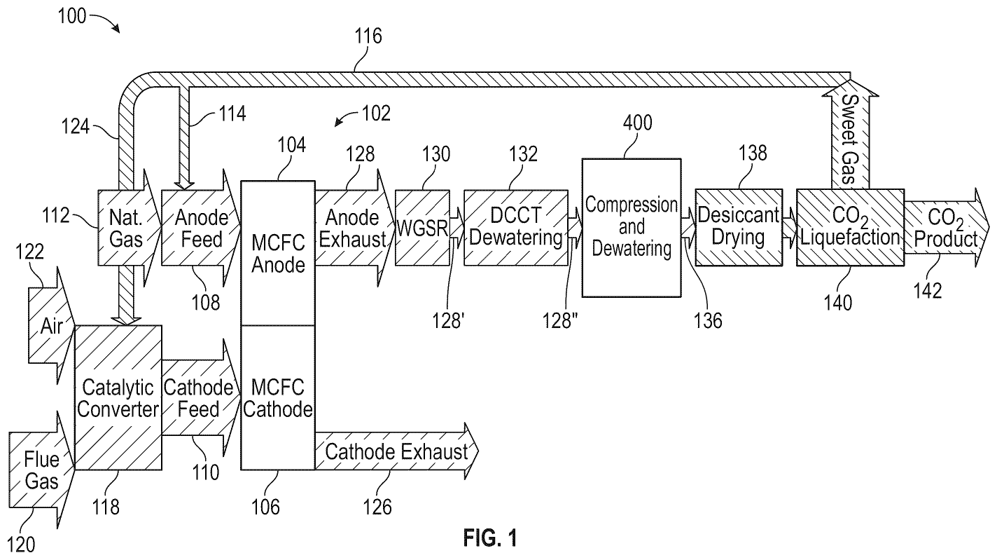

Referring to FIG. 1, a molten carbonate fuel cell (MCFC) system 100 is shown, according to an exemplary embodiment. The MCFC system 100 includes an MCFC module 102, which may include one or more MCFCs. For example, the MCFC module may include one or more stacks of MCFCs, with the anodes of each MCFC in a stack configured to receive one or more anode inlet streams, including fuel, in parallel or in series, and the cathodes of each MCFC in a stack configured to receive one or more cathode inlet streams that include oxygen and carbon dioxide, in parallel or in series. The MCFC module 102 includes an anode section 104 including the anodes of the MCFCs and the gas flow structures that provide the anode input stream 108 to the anodes. The MCFC module 102 also includes a cathode section 106 including the cathodes of the MCFCs and the gas flow structures that provide the cathode input stream 110 to the cathodes. The anode input stream 108 includes a natural gas stream 112, which may include methane, as well as a first portion 114 of a recycle stream 116. The MCFC system 100 further includes a catalytic converter 118 that receives a flue gas stream 120 (e.g., from a power plant or another industrial process) containing carbon dioxide, an air stream 122, and a second portion 124 of the recycle stream 116. The catalytic converter 118 may convert carbon monoxide and hydrocarbons to carbon dioxide and convert nitrogen oxides to nitrogen. The catalytic converter releases the cathode input stream 110 to the cathode section 106.

As discussed above, in the MCFC module 102, carbon dioxide in the cathode input stream 110 is converted to carbonate ions in the MCFC cathodes in the cathode section 106, and the carbonate ions are transported across the electrolytes of the fuel cells to the MCFC anodes in the anode section 104, where they react with hydrogen to form carbon dioxide and water. The cathode section 106 releases a cathode exhaust stream 126 that includes any unreacted components of the cathode input stream 110. The anode section 104 may include reforming catalyst that causes methane and steam in the anode input stream 108 to undergo steam-methane reforming to produce hydrogen and carbon dioxide. The hydrogen reacts with the carbonate ions that have been transported across the electrolytes to form carbon dioxide and water. The anode section 104 releases an anode exhaust stream 128 including the carbon dioxide and water, as well as any unreacted hydrogen, unconverted methane, and any other unreacted or inert components of the anode input stream 108 (e.g., carbon monoxide).

The anode exhaust stream 128 is then supplied to a water-gas shift reactor (WGSR) 130, in which at least some carbon monoxide in the anode exhaust gas stream may react with steam in a water-gas shift reaction to form hydrogen and carbon dioxide. The WGSR 130 releases the “shifted” anode exhaust stream 128′, which may be referred to as a WGSR output stream, to a cooling tower 132 (e.g., a direct contact cooling tower) that cools the shifted anode exhaust stream 128′. The shifted and cooled anode exhaust stream 128″, which may be referred to as a cooler output stream, is supplied to a compression and dewatering system 400, in which the shifted and cooled anode exhaust stream 128″ is compressed and cooled to condense the steam to form liquid water. The liquid water is separated from the remaining gases in the shifted and cooled anode exhaust stream 128″. The dried anode exhaust stream 136 may pass through a desiccant dryer 138, which may remove substantially all of the remaining water in the dried anode exhaust stream 136. The WGSR 130, cooling tower 132, compression and dewatering system 400, and desiccant dryer 138 or any subset thereof may be referred to as a drying system.

The dried anode exhaust stream 136 is then supplied to a carbon dioxide liquefaction system 140, which compresses and further cools the dried anode exhaust stream 136 until the carbon dioxide liquefies and can be separated from the rest of the dried anode exhaust stream 136. The carbon dioxide liquefaction system 140 releases a carbon dioxide product stream 142 and the recycle stream 116. The recycle stream 116 contains the gases remaining after water and carbon dioxide are removed from the anode exhaust stream 128. The recycle stream 116 may be a “sweet gas” stream that primarily contains hydrogen (e.g., 95 mol % or more, or in some embodiments, 97 mol % or more), with a small amount of carbon dioxide and little to no hydrogen sulfide or other sulfur compounds. As discussed above, the recycle stream 116 is split into a first portion 114 supplied to the anode section 104 and a second portion 124 supplied to the catalytic converter 118.

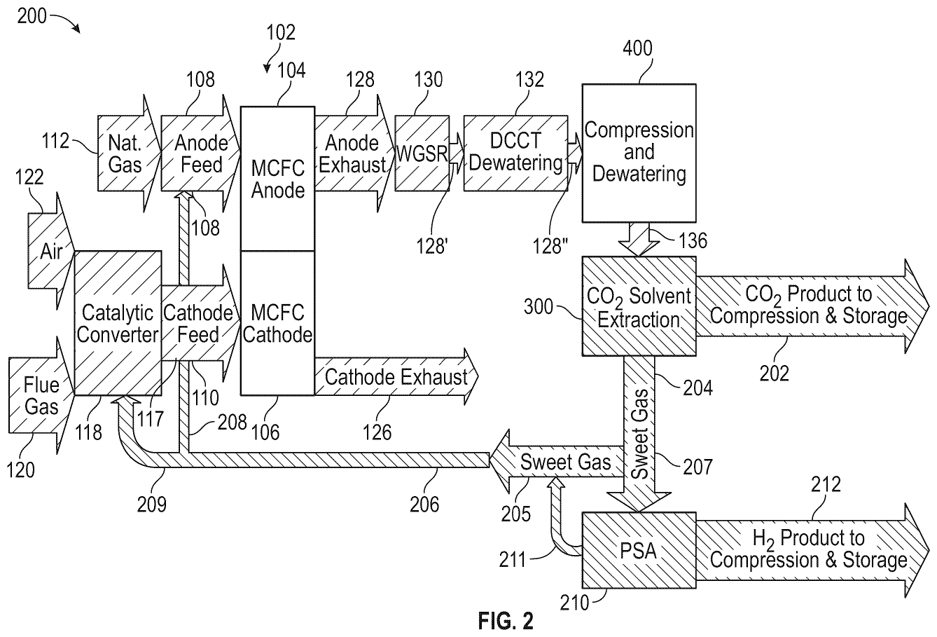

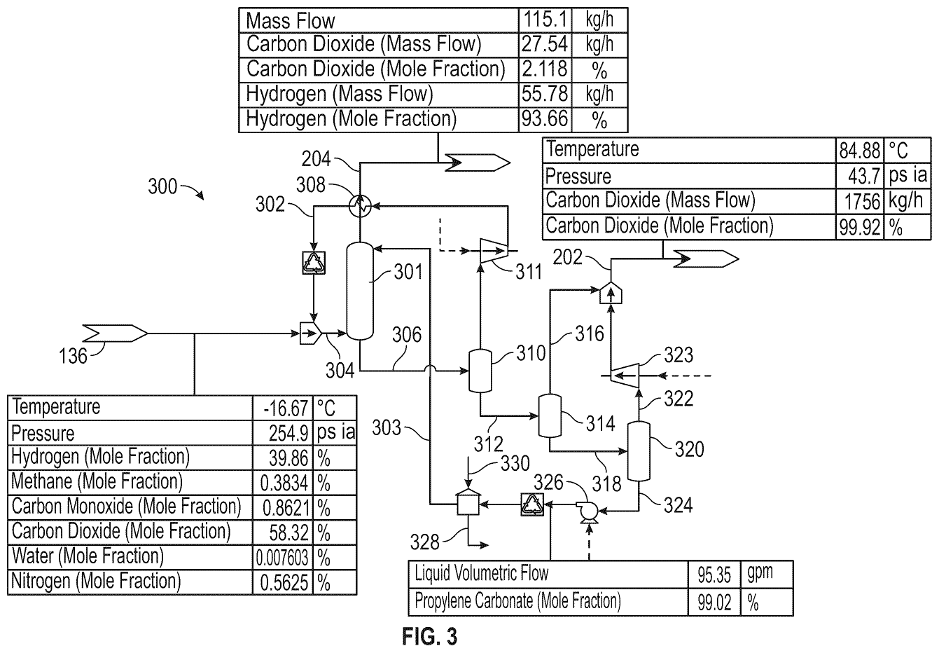

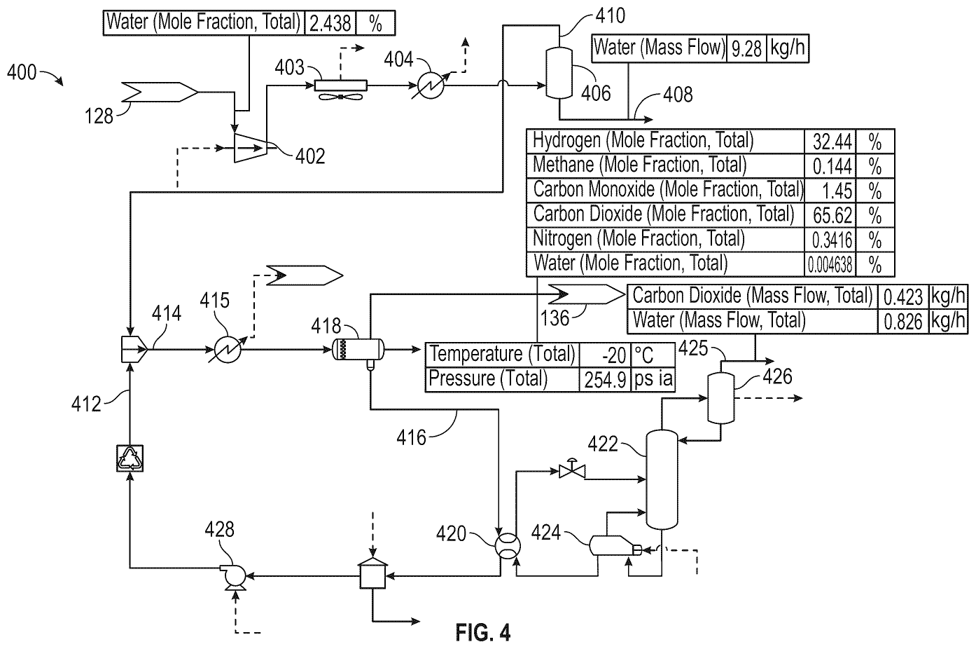

Referring to FIG. 2, an MCFC system 200 is shown according to another exemplary embodiment. In contrast to the MCFC system 100, the MCFC system 200 does not include a desiccant dryer 138 or a carbon dioxide liquefaction system 140. Instead, the MCFC system 200 includes a carbon dioxide solvent extraction system 300, which receives the dried anode exhaust stream 136 from the compression and dewatering system 400. The extraction system 300 is shown in further detail in FIG. 3, and the compression and dewatering system 400 is shown in further detail in FIG. 4. The drying system (e.g., the WGSR 130, cooling tower 132, compression and dewatering system 400) may reduce the water content of the anode exhaust stream 128 to below about 0.1 percent water. The extraction system 300 receives the dried anode exhaust stream 136 and uses a physical solvent such as propylene carbonate to separate carbon dioxide from the dried anode exhaust stream 136. The extraction system 300 releases a carbon dioxide product stream 202 and a sweet gas stream 204 containing the gases remaining from the dried anode exhaust stream 136 (primarily hydrogen).

A first portion 205 of the sweet gas stream 204 forms part of a recycle stream 206 that is split into a first portion 208 supplied to the anode section 104 in the anode input stream 108 and a second portion 209 supplied to the catalytic converter 118. A second portion 207 of the sweet gas stream 204 is supplied to a pressure-swing adsorption system 210. The pressure-swing adsorption system 210 uses pressure-swing adsorption to separate hydrogen from the other gases in the second portion of the sweet gas stream 204. The hydrogen is output as a product hydrogen stream 212, and the remaining gas, referred to as a flash recycle stream 211 is combined with the first portion 205 of the sweet gas stream 204 to form the recycle stream 206. The product hydrogen stream may be over 99 percent pure hydrogen. Thus, the anode input stream 108 may be considered to contain at least a portion of the sweet gas stream 204 and/or at least a portion of the flash recycle stream 211, and/or the catalytic converter may be considered to receive at least a portion of the sweet gas stream 204 and/or at least a portion of the flash recycle stream 211.

As discussed above, FIG. 3 shows the carbon dioxide solvent extraction system 300 in further detail, according to an exemplary embodiment. The dried anode exhaust stream 136 from the compression and dewatering system 400 is combined with the first separator output stream 302 to form an absorber input stream 304, which is supplied to a physical solvent absorber 301 (e.g., an absorption tower 301). The absorber input stream 304 may be supplied to the physical solvent absorber 301 at an elevated pressure, for example, over 200 psi or over 250 psi. The carbon dioxide in the absorber input stream 304 reacts with and is absorbed by a physical solvent, such as propylene carbonate, supplied via the solvent input stream 303. The physical solvent may be sprayed or otherwise distributed at the top of the physical solvent absorber 301, for example, over a packed bed or a series of distillation trays. The gas in the absorber input stream 304 may travel up the absorption tower 301 while the physical solvent, which may be in liquid form, drips or travels down the absorption tower 301, absorbing carbon dioxide from the absorber input stream 304. The absorbed carbon dioxide may be output from the bottom of the physical solvent absorber 301 via the absorber output stream 306. The absorber output stream 306 may also contain other gases from the absorber input stream 304, such as hydrogen or nitrogen, which mix with the physical solvent. The remaining gases from the dried anode exhaust stream 136 are released as the sweet gas stream 204, for example, at the top of the physical solvent absorber 301. The sweet gas stream 204 may pass through a heat exchanger 308 and absorb heat from the first separator output stream 302.

The absorber output stream 306 is supplied to a first separation vessel 310, which separates some of the carbon dioxide from the absorber output stream 306 from the physical solvent by releasing the pressure on the absorber output stream 306. For example, the pressure may decrease from between about 240 psi and about 110 psi to between about 100 psi and about 150 psi. As discussed above, other gases from the absorber input stream 304, such as hydrogen and nitrogen, may also be present in the absorber output stream 306. At the pressure in the first separation vessel, substantially all of the gases other than carbon dioxide (e.g., hydrogen and nitrogen) may be released from the physical solvent, while only a relatively small amount of carbon dioxide may be released. The separated gases are output as the first separator output stream 302, which is compressed in a compressor 311 and recycled to the physical solvent absorber 301. The first separator output stream may contain, for example, about 94 percent hydrogen and 2 percent carbon dioxide. The residual carbon dioxide may remain absorbed in the physical solvent.

The first separation vessel 310 outputs a first solvent output stream 312 containing the physical solvent and residual carbon dioxide, which is then supplied to a second separation vessel 314. Similar to the first separation vessel 310, the second separation vessel 314 separates some of the carbon dioxide from the physical solvent by reducing the pressure of the first solvent output stream 312, for example, to between about 65 psi and about 75 psi.

The second separation vessel 314 releases a second separator output stream 316 containing primarily carbon dioxide and a second solvent output stream 318 containing the physical solvent and residual carbon dioxide. The second solvent output stream 318 is supplied to a third separation vessel 320. The third separation vessel 320 may reduce the pressure of the second solvent output stream 318 to about atmospheric pressure, which may release all or nearly all of the remaining carbon dioxide from the physical solvent.

The third separation vessel 320 releases a third separator output stream 322, which is pressurized by a compressor 323 (e.g., to between about 65 psi and about 75 psi) and is combined with the second separator output stream 316 to form the carbon dioxide product stream 202. Compared to a system with only two separation vessels (e.g., the first and third separation vessels 310, 320), adding an additional separation vessel (e.g., the second separation vessel 314) that releases substantially pure carbon dioxide at elevated pressure reduces the energy needed to compress the purified carbon dioxide because a portion of the carbon dioxide may already be partially pressurized.

The carbon dioxide product stream 202 may be over 99 percent pure carbon dioxide, and in some cases may be over 99.9 percent pure carbon dioxide. This is in part because the gases separated from the physical solvent in the first separation vessel 310, which include nearly all of the hydrogen and nitrogen and a portion of the carbon dioxide, are recycled back to the physical solvent absorber 301 rather than being mixed with the second separator output stream 316 and the third separator output stream 322 to form the carbon dioxide product stream 202. Thus, the carbon dioxide product stream 202 may be substantially pure carbon dioxide, though a portion of the carbon dioxide separated from the physical solvent is returned to the physical solvent absorber 301.

Removing water from the anode exhaust stream 128 before supplying the dried anode exhaust stream 136 to the physical solvent absorber 301 may also improve the efficiency of the separation process both by removing water and by reducing the temperature and increasing the pressure of the dried anode exhaust stream 136. For example, the dried anode exhaust stream 136 may be below about 0 degrees Celsius (and in some cases below about −20 degrees Celsius) and above about 225 psi (and in some cases above about 250 psi) when supplied to the physical solvent absorber 301. In embodiments in which propylene carbonate is used as the physical solvent, removal of water may greatly improve the efficiency of the separation process. Other physical solvents typically undergo heating in distillation towers, which requires significant amounts of heat and energy to evaporate entrained water. The separation process using propylene carbonate does not require evaporation of water and takes place between about −30 degrees Celsius and about 5 degrees Celsius. Removal of water before this process may ensure that the propylene carbonate is not diluted when it is recycled to the physical solvent absorber 301. The elimination of heating and cooling steps that may be required when other physical solvents are utilized may reduce the energy required to separate carbon dioxide from the anode exhaust stream 128.

Typical carbon dioxide separation systems that utilize solvents like Selexol may require multiple absorbers with cooling systems between each absorber in order to obtain carbon dioxide with purity levels above 95 percent. In contrast, by dewatering and cooling the anode exhaust stream 128, using propylene carbonate, and using a three-step separation system, the need for multiple absorbers and cooling systems may be eliminated, resulting in a purer carbon dioxide product stream (e.g., more than 99 percent, and in some cases more than 99.9 percent pure) using less energy.

The third separation vessel 320 releases a third solvent output stream 324 that contains primarily (e.g., over 99 percent) physical solvent from the second solvent output stream 318 and some residual components, such as residual carbon dioxide. The third solvent output stream 324 is pumped back toward the physical solvent absorber 301 by a pump 326. To avoid a buildup of residual components, a very small portion of the third solvent output stream 324 is discarded via a solvent output stream 328 and replaced with substantially pure physical solvent via a makeup solvent stream 330. For example, if the solvent output stream 328 contains 99 percent physical solvent, the volume (or volumetric flow rate) of solvent added via the makeup solvent stream 330 may be approximately equal to 99 percent of the volume (or volumetric flow rate) of the third solvent output stream 324. After adding the makeup solvent stream 330, the physical solvent is pumped to the physical solvent absorber 301 as the solvent input stream 303.

As discussed above, FIG. 4 shows the compression and dewatering system 400 in further detail, according to an exemplary embodiment. After the anode exhaust stream 128 undergoes a water-gas shift reaction in the WGSR 130 and is initially dewatered in the cooling tower 132, the shifted and cooled anode exhaust stream 128″ is supplied to a first compressor 402 of the compression and dewatering system 400 and pressurized. The compressed anode exhaust is cooled in a cooler 403 and a first heat exchanger 404 and supplied to a first separation vessel 406, in which the compressed and cooled anode exhaust splits into a liquid water stream 408 and a separated gas stream 410.

The separated gas stream 410, from which most of the water (e.g., water vapor) has been removed, is then mixed with a glycol stream 412 to form a mixed stream 414, which is supplied to a propane cooler 415 and further cooled. The ethylene glycol in the glycol stream 412 absorbs the water in the separated gas stream 410, and the cooled mixed stream 414 is separated into the dried anode exhaust stream 136 and a separator stream 416 in a low-temperature separator 418. The separator stream 416, containing mostly water and ethylene glycol, is heated in a heat exchanger 420 and then is directed to an ethylene glycol regenerator 422 and a reboiler 424 to further remove water from any remaining gas in the separator stream 416. The ethylene glycol regenerator 422 and reboiler 424 heat the separator stream 416 to vaporize water. The vaporized water is supplied to a condenser 426, along with any carbon dioxide remaining in the separator stream 416 and any ethylene glycol vaporized in the regenerator 422.

Water vapor is released via the exhaust stream 425, while ethylene glycol that reaches the condenser 426 is condensed and returned to the regenerator 422. Liquid ethylene glycol is separated from the reboiler 424 and recycled as the glycol stream 412. The glycol stream 412 is supplied to the heat exchanger 420, where heat from the glycol stream 412 is transferred to the separator stream 416. Some of the glycol stream 412 may be discharged from the system and replaced with fresh ethylene glycol to reduce the buildup of contaminants in the glycol stream 412 as the ethylene glycol is repeatedly recycled. A pump 428 pumps the glycol stream 412 to combine it with the separated gas stream 410 to form the mixed stream 414. The resulting dried anode exhaust stream 136 output from the compression and dewatering system 400 to the carbon dioxide solvent extraction system 300 may comprise less than 0.01 percent water (or less than 0.005 percent water). This may increase the efficacy of the carbon dioxide solvent extraction system 300 and allow for more, higher purity carbon dioxide to be captured.

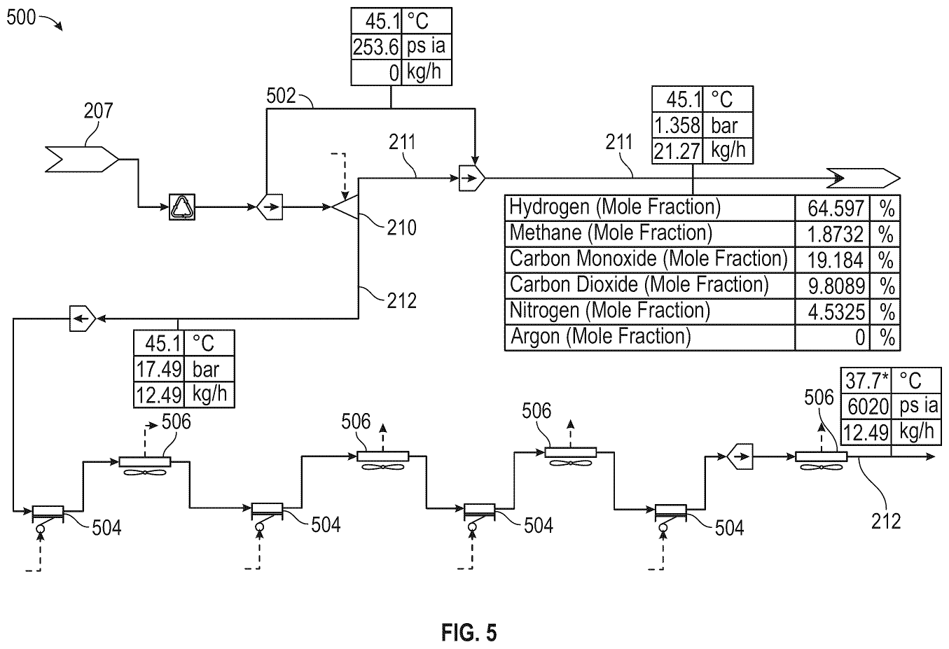

Referring now to FIG. 5, the hydrogen capture system 500 is shown in further detail, according to an exemplary embodiment. As discussed above, the second portion 207 of the sweet gas stream 204 is supplied to the pressure-swing adsorption system 210, which separates the second portion 207 into the product hydrogen stream 212, and the flash recycle stream 211. In some embodiments, the hydrogen capture system 500 may include a bypass stream 502 in which some of the second portion 207 of the sweet gas stream 204 may bypass the pressure-swing adsorption system 210, for example, if the volume of gas in the second portion 207 of the sweet gas stream 204 exceeds the processing capacity of the pressure-swing adsorption system 210. The bypass stream 502 may be combined with the flash recycle stream 211 downstream of the pressure-swing adsorption system 210. As discussed above, the flash recycle stream 211 may be combined with the first portion 205 of the sweet gas stream 204 to form the recycle stream 206. The product hydrogen stream 212 is repeatedly compressed and cooled by a series of compressors 504 and coolers 506.

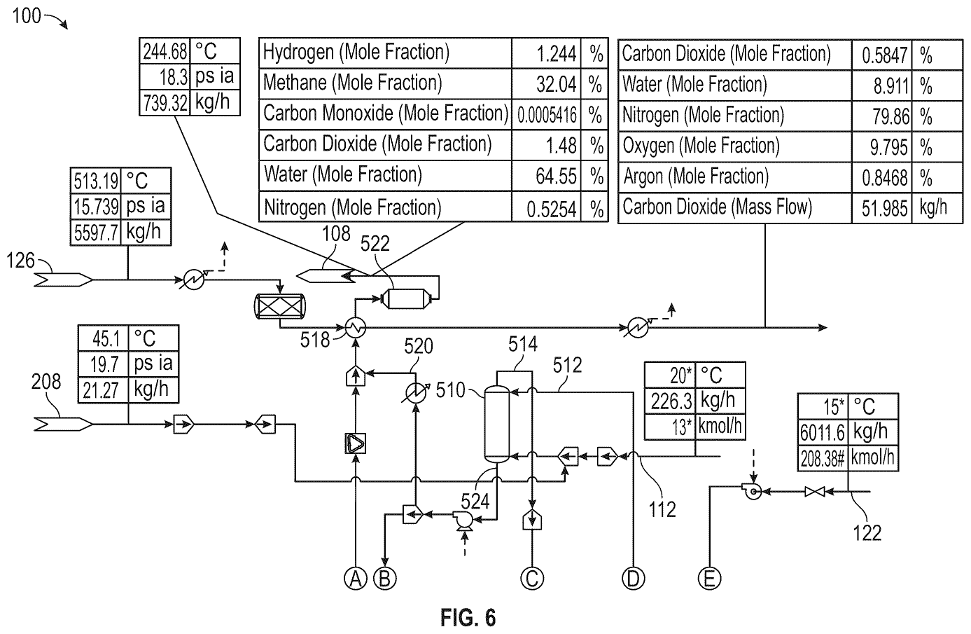

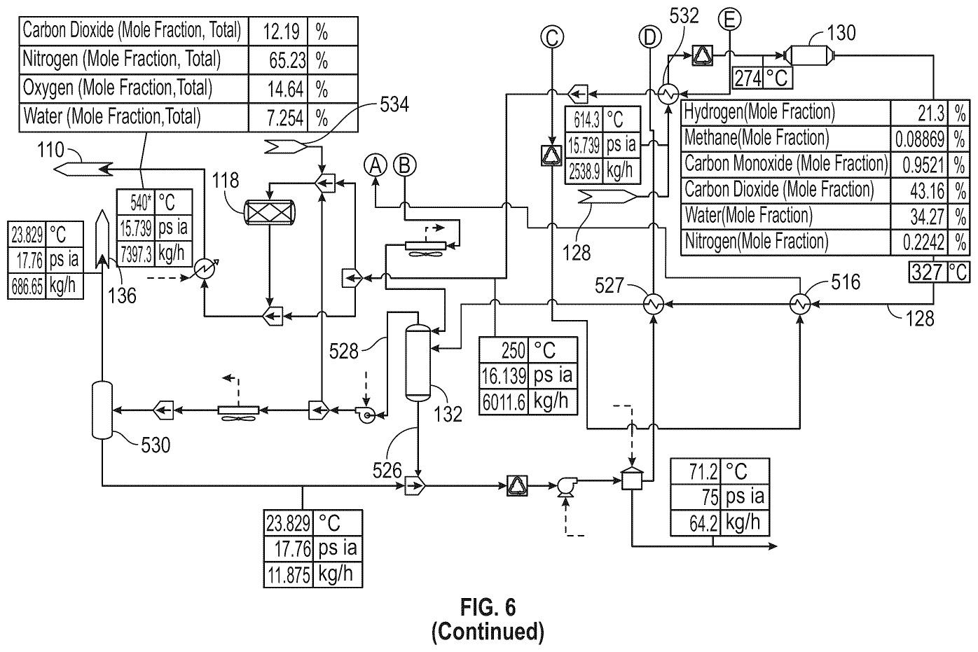

Referring now to FIG. 6, a portion of the MCFC system 100 is shown in further detail, according to an exemplary embodiment. The first portion 208 of the recycle stream 206, containing sweet gas that includes primarily (e.g., 95 mol % or more, or in some embodiments, 97 mol % or more) hydrogen with a small amount of carbon dioxide and little to no hydrogen sulfide or other sulfur compounds, is combined with the natural gas stream 112 and supplied to a saturator 510. A water stream 512 is also supplied to the saturator 510, which humidifies and saturates the combined first portion 208 and natural gas stream 112 for use in the anode input stream 108 of the MCFC module 102. A saturated fuel stream 514 is output from the saturator 510. The saturated fuel stream 514 is heated in a first heat exchanger 516 by the shifted anode exhaust 128′ output by the WGSR 130 and in a second heat exchanger 518 by the cathode exhaust stream 126. The saturated fuel stream 514 may be further humidified by mixing with a steam stream 520. The saturated fuel stream 514 is supplied to a preconverter 522 for converting a portion of the natural gas in the saturated fuel stream 514 to hydrogen in a reforming reaction. The preconverter 522 then outputs the anode input stream 108, which is supplied to the MCFC module 102.

The saturator 510 also outputs a water stream 524 containing any liquid water that condenses in the saturator 510. A portion of the liquid water stream 524 may be heated to form the steam stream 520, which is mixed with the saturated fuel stream 514 and supplied to the preconverter 522, as discussed above. The remaining portion of the liquid water stream 524 is supplied to the cooling tower 132, where it is sprayed over the shifted anode exhaust stream 128′ supplied from the WGSR 130 to the cooling tower 132. Water vapor in the shifted anode exhaust stream 128′ condenses and is output via the cooling tower water stream 526. A portion of the cooling tower water stream 526 is discharged from the system. The remaining water forms the water stream 512, which is heated in a third heat exchanger 527 by the shifted anode exhaust stream 128′ from the WGSR 130 and then supplied to the saturator 510.

The cooling tower 132 outputs a partially dried anode exhaust stream 528, a portion of which may be supplied to a catalytic converter 118 along with a portion of the air stream 122. As discussed above, the catalytic converter 118 oxidizes these gas streams and outputs a catalytic converter output stream 117, which may form all or part of the cathode input stream 110. Some of the carbon dioxide product stream 202 may also be recycled via a carbon dioxide recycle stream 534 to the cathode input stream 110 to ensure that there is sufficient carbon dioxide for operation of the MCFC module 102. A portion of the air stream 122 may bypass the catalytic converter 118 and be combined with the output from the catalytic converter 118 to form the cathode input stream 110. The remaining portion of the partially dried anode exhaust stream 528 is supplied to a condenser vessel 530, in which more water in the partially dried anode exhaust stream 528 may condense. The condenser vessel 530 outputs the dried anode exhaust stream 136, which is supplied to the carbon dioxide solvent extraction system 300, and a condensed water stream, which may be combined with the liquid water stream 524.

The anode exhaust stream 128 from the MCFC module 102 is supplied to a fourth heat exchanger 532 and used to heat the air stream 122 before being supplied to the WGSR 130. As discussed above, the WGSR outputs a shifted anode exhaust stream 128′ that is used to heat the saturated fuel stream 514 in the first heat exchanger 516 and the water stream 512 in the third heat exchanger 527 before being supplied to the cooling tower 132.

While this specification contains specific implementation details, these should not be construed as limitations on the scope of what may be claimed but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable subcombination. Moreover, although features may be described as acting in certain combinations and even initially claimed as such, one or more features from a claimed combination can, in some cases, be excised from the combination, and the claimed combination may be directed to a subcombination or variation of a subcombination.

As utilized herein, the terms “substantially,” “generally,” “approximately,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the appended claims.

More particularly, various numerical values herein are provided for reference purposes only. Unless otherwise indicated, all numbers expressing quantities of properties, parameters, conditions, and so forth, used in the specification and claims are to be understood as being modified in all instances by the term “approximately” or “about.” Accordingly, unless indicated to the contrary, the numerical parameters set forth in the following specification and attached claims are approximations. Any numerical parameter should at least be construed in light of the number of significant digits and by applying ordinary rounding techniques. The term “approximately” or “about” when used before a numerical designation, e.g., a quantity and/or an amount including range, indicates approximations which may vary by (+) or (−) 10 percent.

The term “coupled” and the like, as used herein, mean the joining of two components directly or indirectly to one another. Such joining may be stationary (e.g., permanent) or moveable (e.g., removable or releasable). Such joining may be achieved with the two or the two components and any additional intermediate components being integrally formed as a single unitary body with one another, with the two components, or with the two components and any additional intermediate components being attached to one another.

It is important to note that the construction and arrangement of the various systems shown in the various example implementations are illustrative only and not restrictive in character. All changes and modifications that come within the spirit and/or scope of the described implementations are desired to be protected. It should be understood that some features may not be necessary, and implementations lacking the various features may be contemplated as within the scope of the disclosure, the scope being defined by the claims that follow. When the language “a portion” is used, the item can include a portion and/or the entire item unless specifically stated to the contrary.

What is claimed is:

1. A fuel cell system comprising:
a molten carbonate fuel cell module comprising an anode section and a cathode section, wherein the anode section is configured to output an anode exhaust stream comprising carbon dioxide and hydrogen, and the cathode section is configured to receive a cathode input stream;
a drying system configured to receive and remove water from the anode exhaust stream and to output a dried anode exhaust stream comprising less than 0.1 percent water; and
a carbon dioxide solvent extraction system configured to receive the dried anode exhaust stream, expose the dried anode exhaust stream to a physical solvent to absorb carbon dioxide, output a carbon dioxide product stream comprising at least 99 percent carbon dioxide, and output a sweet gas stream.

2. The fuel cell system of claim 1, wherein the physical solvent is propylene carbonate.

3. The fuel cell system of claim 1, wherein the anode section is configured to receive an anode input stream comprising at least a portion of the sweet gas stream.

4. The fuel cell system of claim 1, further comprising a catalytic converter configured to:
receive an air stream and at least a portion of the sweet gas stream;
oxidize the at least the portion of the sweet gas stream; and
output a catalytic converter output stream, wherein the cathode input stream comprises the catalytic converter output stream.

5. The fuel cell system of claim 1, further comprising a pressure-swing adsorption system configured to receive at least a portion of the sweet gas stream and to output a product hydrogen stream comprising at least 99 percent hydrogen and a flash recycle stream, wherein the anode section is configured to receive an anode input stream comprising at least a portion of the flash recycle stream.

6. The fuel cell system of claim 5, further comprising a catalytic converter configured to:
receive an air stream and at least a portion of the sweet gas stream;
oxidize the at least the portion of the sweet gas stream; and
output a catalytic converter output stream, wherein the cathode input stream comprises the catalytic converter output stream.

7. The fuel cell system of claim 1, wherein the carbon dioxide solvent extraction system includes an absorption tower configured to:
receive a solvent input stream comprising the physical solvent;
receive an absorber input stream comprising the dried anode exhaust stream;
expose the absorber input stream to the physical solvent;
output the sweet gas stream; and
output an absorber output stream comprising physical solvent and carbon dioxide.

8. The fuel cell system of claim 7, wherein the carbon dioxide solvent extraction system comprises:
a first separation vessel configured to separate the absorber output stream into a first separator output stream comprising hydrogen and a first solvent output stream comprising carbon dioxide absorbed in physical solvent;
a second separation vessel configured to separate the first solvent output stream into a second separator output stream comprising at least 99 percent carbon dioxide and a second solvent output stream comprising carbon dioxide absorbed in physical solvent; and
a third separation vessel configured to separate the second solvent output stream into a third separator output stream comprising at least 99 percent carbon dioxide and a third solvent output stream comprising physical solvent.

9. The fuel cell system of claim 8, wherein the absorber input stream comprises the first separator output stream.

10. The fuel cell system of claim 9, further comprising:
a compressor configured to pressurize the first separator output stream; and
a heat exchanger configured to transfer heat from the pressurized first separator output stream to the sweet gas stream.

11. The fuel cell system of claim 8, wherein the second separation vessel is configured to output the second separator output stream at a pressure above 30 pounds per square inch, and the third separation vessel is configured to output the third separator output stream at approximately atmospheric pressure.

12. The fuel cell system of claim 11, wherein the carbon dioxide solvent extraction system further comprises a compressor configured to pressurize the third separator output stream, wherein the carbon dioxide product stream comprises the second separator output stream and the pressurized third separator output stream.

13. The fuel cell system of claim 8, wherein the solvent input stream comprises physical solvent from the third solvent output stream.

14. A method of operating a molten carbonate fuel cell system, the method comprising:
removing water from an anode exhaust stream from an anode section of a molten carbonate fuel cell module to generate a dried anode exhaust stream comprising less than 0.1 percent water;
exposing the dried anode exhaust stream to a physical solvent to absorb carbon dioxide in the dried anode exhaust stream and generate a sweet gas stream comprising hydrogen; and
separating carbon dioxide from the physical solvent to generate a carbon dioxide product stream comprising at least 99 percent carbon dioxide.

15. The method of claim 14, wherein the physical solvent is propylene carbonate.

16. The method of claim 14, further comprising at least one of:
(a) supplying to the anode section an anode input stream comprising at least a portion of the sweet gas stream; or
(b) oxidizing at least a portion of the sweet gas stream in a catalytic converter to generate a catalytic converter output stream, and supplying to a cathode section of the molten carbonate fuel cell system a cathode input stream comprising the catalytic converter output stream.

17. The method of claim 14, further comprising separating at least a portion of the sweet gas stream into a product hydrogen stream comprising at least 99 percent hydrogen and a flash recycle stream using pressure-swing adsorption, and at least one of:
(a) supplying at least a portion of the flash recycle stream to the anode section; or
(b) oxidizing at least a portion of the flash recycle stream in a catalytic converter to generate a catalytic converter output stream, and supplying to a cathode section of the molten carbonate fuel cell system a cathode input stream comprising the catalytic converter output stream.

18. The method of claim 14, wherein exposing the dried anode exhaust stream to a physical solvent comprises:
supplying a physical solvent input stream comprising the physical solvent to an absorption tower;
supplying an absorber input stream comprising the dried anode exhaust stream to the absorption tower; and
exposing the absorber input stream to the physical solvent in the absorption tower to generate an absorber output stream comprising carbon dioxide absorbed in physical solvent.

19. The method of claim 18, wherein separating carbon dioxide from the physical solvent comprises:
reducing the pressure of the absorber output stream in a first separation vessel to separate the absorber output stream into a first separator output stream comprising hydrogen and a first solvent output stream comprising carbon dioxide absorbed in physical solvent;
reducing the pressure of the first solvent output stream in a second separation vessel configured to separate the first solvent output stream into a second separator output stream comprising at least 99 percent carbon dioxide and a second solvent output stream comprising carbon dioxide absorbed in physical solvent; and
reducing the pressure of the second solvent output stream in a third separation vessel configured to separate the second solvent output stream into a third separator output stream comprising at least 99 percent carbon dioxide and a third solvent output stream comprising physical solvent.

20. The method of claim 19, wherein the absorber input stream comprises the first separator output stream, the method further comprising pressurizing the first separator output stream and transferring heat from the pressurized first separator output stream to the sweet gas stream.

21. The method of claim 19, further comprising pressurizing the third separator output stream, combining the pressurized third separator output stream with the second separator output stream, and compressing and storing the combined second and third separator output streams.
